(19) United States
(12) Patent Application Publication
(10) Pub. No.: US 2005/0045451 A1
(43) Pub. Date: Mar. 3, 2005

(54) Feeder loading

(75) Inventor: Peter Berdelle-Hilge, Konstanz (DE)

Correspondence Address: YOUNG & THOMPSON, 745 SOUTH 23RD STREET, 2ND FLOOR, ARLINGTON, VA, 22202, US

(73) Assignee: SIEMENS AKTIENGESELLSCHAFT, MUNICH (DE)

(21) Appl. No.: 10/933,341

(22) Filed: Sep. 3, 2004

Related U.S. Application Data
(60) Provisional application No. 60/499,612, filed on Sep. 3, 2003.

(51) Int. Cl. B65G 47/26

(52) U.S. Cl. 198/418

(57) ABSTRACT

The present invention is directed to a system and method for loading articles onto a feeder ledge of a feeder, the articles arriving from a plurality of different article lines. One line may be reserved for automatically loadable articles, while a second line may be directed to semi-automatic loading. Semi-automatic loading entails directing an article container or tub to an operator who then manually aligns and makes any necessary alignment corrections to an article stack accommodated therein. After a sufficient amount of manual handling, articles located upon a second ledge, as prepared by the operator, are substituted in the automatically loadable article stream to the feeder ledge. As such, the operator prepared articles get loaded upon the feeder ledge. During this time, it may be possible for the operator to manually load still more articles from a third article line directly onto the feeder ledge.

### CROSS REFERENCE TO RELATED APPLICATIONS

The present application claims priority to provisional patent application 60/499,612, filed on Sep. 03, 2003, which is herein incorporated by reference.

### BACKGROUND OF THE INVENTION

The present invention relates to the field of article handling and more particularly to a system and method for merging multiple article lines onto a single feeder ledge. The multiple article lines may include automatic, semi-automatic and manual articles handling procedures. As used throughout the application, articles may refer to at least one a mail, book, magazine and compact disk.

The throughput of automatic singulators or feeders is limited to the loading throughput of the feeder bed or ledge with articles. This is especially true if the arriving articles are contained in several different types of containers. Likewise, the arriving articles may be bundled and/or polywrapped thereby requiring additional attention. Articles may arrive at a feeder from a variety of sources, including loaded in trays and carts. The articles themselves may be stacked in longer stacks of about one meter, commonly referred to as a “log”, and shorter stacks as may be found in a common tub. Additionally, the articles may arrive bundled and or polywrapped together. Accordingly, with certain articles, manual intervention is at least partially necessary in order to ensure and/or preserve the preciseness of the article step. In other words, such manual intervention may address article skews, dislodgement, non-alignment and so forth. Therefore in order to address throughput to feeder, it is necessary to consider the types of articles arriving and their particular requirements. Accordingly, a need exists to increase throughput while not compromising performance, costs, and engineering requirements while still taking the aforementioned requirements into consideration.

### SUMMARY OF THE INVENTION

An advantage of the present invention is to provide a system and method for merging the aforementioned article lines with increased throughput while still attending to the particular needs of the articles mentioned above. Another advantage is that the handling of different mail streams is performed substantially concurrently making at least one of them always available to the feeder ledge. These and other advantages are provided by introducing a first and second ledge to serve automatically feedable and semi-automatically feedable articles. The feeder ledge remains static. The ledges are connected to their respective article conveying and delivery means as well as the feeder ledge. Interspaced between ledge and respective article conveyor is an article transport means. For the first ledge, the transport means includes a lift and automatic article gripping means for retrieving the automatically feedable articles (article logs) from their respective containers. For the second ledge, the transport means includes at least one vertically displacing lifts to retrieving tubs of articles and a conveying means, such as a track, running over or under the first ledge, transporting the tubs to the second ledge. The second ledge abuts the first ledge. The first ledge further include automatic article transport means, such as overhead paddles or fingers. The second ledge includes a flat surface upon which an operator may work.

In operation, a tub is conveyed to an operator who puts his/her hand atop the articles within the tub and the tub is rotated in an upside down direction such that the article rest upon a transition device with the operator's hand providing suitable support to prevent the articles from displacing unwantedly. This device could be used for transporting the articles to the second ledge and the left side of the second ledge in particular. Other delivery areas on the second ledge are conceivable by way of design. The operator may then realign, adjust or otherwise manipulate the articles. When the operator has a sufficient number of articles on the second ledge, he/she pushes the ledge against the first ledge thereby displacing the first ledge and substituting the second ledge therefor. The automatic article transport means associated with the first ledge is now associated with the second ledge thereby facilitating transport of the articles currently located thereon. After all of the second ledge articles have been transported to the feeder ledge, the second ledge is retrieved facilitating return of the first ledge to its original place.

In another embodiment, a second operator may be stationed proximate to the automatically feedale article lift armed with sufficient or appropriate means for removing a polywrapping or bundling.

In another embodiment, a cart carrying other articles may be introduced to the operator for manual loading upon the feeder ledge.

### BRIEF DESCRIPTION OF THE SEVERAL VIEWS OF THE DRAWINGS

These and other embodiments will be set out in more detail below with general reference to the figures, comprising:

FIG. 1 depicts a top schematic view of a first embodiment of the present invention; and

FIG. 2 depicts a top schematic view of a second embodiment of the present invention.

### DETAILED DESCRIPTION OF THE INVENTION

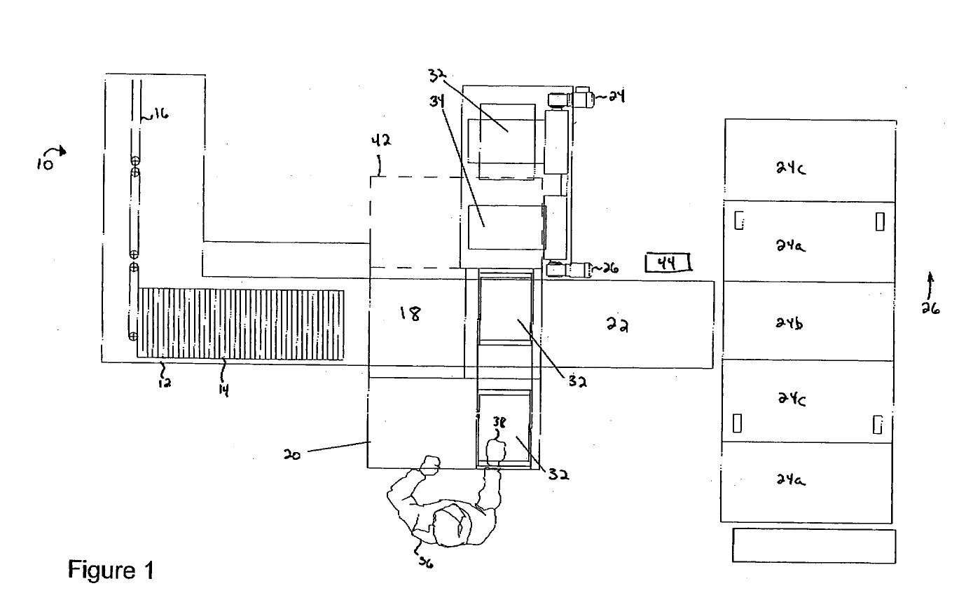

FIG. 1 depicts a top schematic view of a first embodiment of the present invention. As shown, a feeder 10, includes a feeder ledge 12 upon which a plurality of articles 14 are to be introduced. Maximizing use of the feeder ledge maximizes throughput of the feeder. As is known in the art, the feeder 10 includes coaxial rollers and such 16 to facilitate singulation of the articles. The present system further includes a first and second ledge 18 and 20. The first ledge is substantially coaxial with a first lift 22, itself adjacent a first article conveyor 24. The first article conveyor 24, or automatically feedable article conveyor, may comprise a plurality of carts, having three columns 24a, 24b, 24c and three vertically displaced rows (not shown). The number of columns, rows and carts is a matter of design. The carts 24 are indexed in a direction perpendicular to the figure (arrow 26) by an indexer (not shown). The conveyor 24 may include three vertically displaced levels which would be serviced by first lift or automatically feedable article lift 22. The conveyor 24 may accommodate article logs in appropriate containers. Article logs are articles arranged in a stack at about one meter long. The system includes appropriate means for retrieving the article logs automatically and depositing them upon the lift. The lift in turn ascends or descends to the level of the first ledge 18. The system includes appropriate article conveyor means for removing the article log from its container, placing it upon the surface of the first ledge 18 and conveying it to the feeder ledge 12. Such appropriate means may include an overhead paddle and/or fingers (from top, side or bottom) and/or other such means as known in the art. Accordingly, article logs are automatically conveyed from conveyor 24 to feeder ledge 12 over first ledge 18 and lift 22. The internal workings and material choice for the aforementioned is a matter of design choice known to one skilled in the art.

In case the article logs are polywrapped or bundled, an operator 44 may be stationed proximate to lift 22 armed with appropriate means for depolywrapping or debundling the article log. Such appropriate means may include a blade and the like.

As depicted, the second feeder line is serviced via two lifts 24 and 26 having a shelf 30. As may be envisioned by the skilled person, an other number of lifts or no lifts may be used. The two lifts may service tubs or similar such containers. One lift may be reserved for ascending without tubs one its shelf (lift 26) while another (lift 24) for descending tubs from an overhead conveyor (not shown). A tub conveyor may be implemented to convey tubs to the lifts from a certain height. Accordingly, a first lift 24 rises (or lowers) to retrieve filled tubs and bring them to a tub conveyor 28. The tub 32 is then conveyed via track 34 over first ledge 18 to second ledge 20. At the second ledge, the operator 36 places his/her hand upon the articles and the tub is rotated, by appropriate mechanical means, in an upside down direction so as to at least be partially guided by the operator's hand 38 (hence the term semi-automatic) and unload the articles into a conveyor device (not shown). The tub 32 is returned to track 34, to second lift 36, and vertically relocated to the tub conveyor. The operator 36 selectively positions the conveyor device about the second ledge so that he/she may conveniently unload the articles. The aforementioned tub/article introduction to operator is repeated until the operator has a sufficient amount of articles appropriately stacked on the second ledge 20. Appropriately stacked articles are ones where the operator has addressed any misalignment, skews, offsets and the like among the articles. Through out this process, the articles from the first line, or automatically feedable articles, are being fed to the feeder ledge 12. This is made possible by the track 34 which runs above the first ledge so as not to interfere with the flow of automatically feedable articles. In an alternative embodiment, the track 34 may run below the first ledge 18. After the operator 36 has an appropriate number of articles on the second ledge 20, he/she initiates an interruption, waits for a pause, and such, and pushes the second ledge 20 forward (direction arrow 40) against the first ledge 18. As shown the second ledge abuts the fist ledge, although other positions for each ledge may be envisioned provided the automatically feedable articles are automatically fed from cart 24 to feeder ledge 12 and both ledges 18 and 20 remain relocatable. This action relocates the first ledge to an out position 42 and substitutes the second ledge 20 in its place. The automatic article conveyor means, formally servicing the articles on the first ledge is now in a position to service the articles upon the second ledge. The articles upon the second ledge are (as with the ones from the first) automatically conveyed to feeder ledge 12. Alternatively, the articles on the second ledge may be manually conveyed from the second ledge to the feeder ledge, before or after the second ledge is in the position of the first ledge.

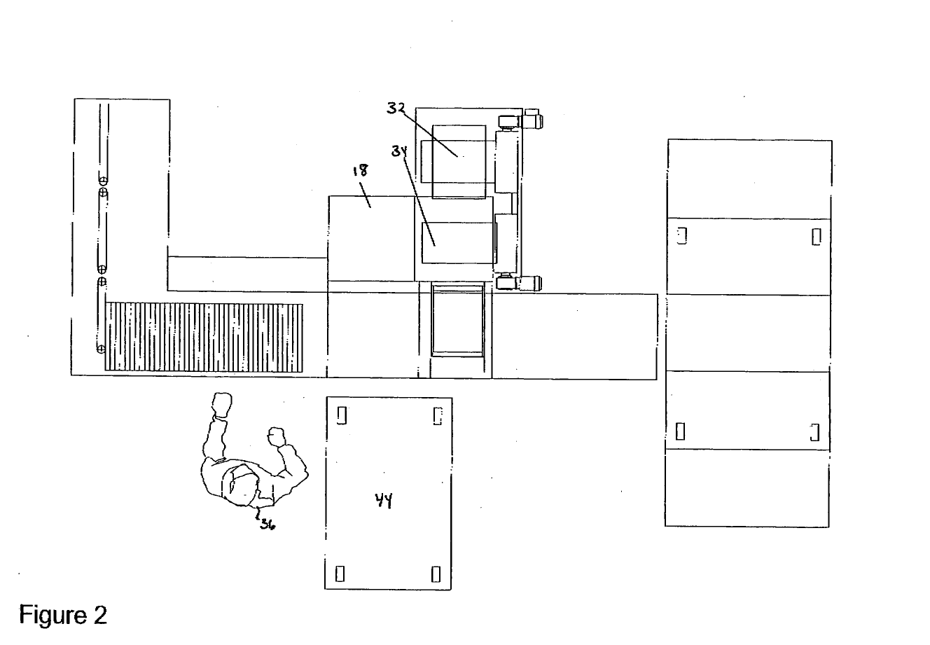

FIG. 2 depicts an another embodiment of the present invention wherein a tray cart 44 is now present. The tray cart nay be positioned proximate to the operator when the second ledge 20 replaces the first ledge 18 (as is depicted in FIG. 2). The operator manually relocates articles located on and/or in tray cart 44 onto the feeder ledge 12. This throughput, alone, is sufficient to maintain all overall throughput by keeping the feeder sufficiently occupied.

According to the above described invention, throughput is increased because no pauses are encountered during feeder loading of articles and the operator's tasks versus time may be maximized. As such, the number of articles 14 located upon feeder ledge 12 will be maximized.

The invention being thus described, it will be obvious that the same may be varied in many ways. Such variations are not to be regarded as a departure from the spirit and scope of the invention, and all such modifications would be obvious to one skilled in the art are intended to be included within the scope of the following claims. Such modifications may include the number and location of extraction devices to slots.

1. A system for merging different article streams onto a feeder ledge, comprising:
a first ledge arranged to effect a first throughput of automatically loadable articles to the feeder ledge;
a second ledge arranged to effect a second throughput of semi-automatic articles to the feeder ledge; and
means for interrupting said first throughput so as to introduce said second throughput.

2. The system according to claim 1, further comprises manual loading means arranged to effect a third throughput of manually handled articles.

3. The system according to claim 2, wherein said means for interrupting comprises laterally displacement means attached to said first and second ledge such that a force on said second ledge urges said first ledge out of position and substitutes said second ledge into said position.

4. The system according to claim 1, further comprising a first article introduction means arranged to introduce articles to said first ledge, said articles arranged so as not to require manual reorientation.

5. The system according to claim 2, further comprising a second article introduction means arranged to introduce trays accommodating articles therein.

6. The system according to claim 5, wherein said second article introduction means further comprises at least one first lift for descending article accommodating trays from a tray conveyor and at least one second lift for ascending empty trays to said tray conveyor.

7. The system according to claim 6, wherein said second article introduction means further comprises a track arranged to transport articles from said at least one first lift over said first ledge to said second ledge such that said first throughput is uninterrupted by said track.

8. The system according to claim 6, wherein said second article introduction means further comprises a track arranged to transport articles under said first ledge to said second ledge such that said first throughput is uninterrupted by said track.

9. The system according to claim 1, further comprising a cart system for introducing said automatically loadable articles to said first ledge, said cart system comprising: a series of abutting carts including a number of columns and shelves each arranged to transport a number of automatically loadable articles; and an automatically loadable articles lift for lifting articles from each of said shelves to said first ledge.

10. The system according to claim 9, wherein said fist ledge further comprises automatically loadable articles transport means arranged to automatically transport said automatically loadable articles from said automatically loadable articles lift to said feeder ledge.

11. The system according to claim 9, wherein said automatically loadable articles lift further comprises automatically loadable articles transport means arranged to automatically transport said automatically loadable articles from said automatically loadable articles lift to said first ledge.

12. The system according to claim 10, wherein said automatically loadable articles lift further comprises automatically loadable articles transport means arranged to automatically transport said automatically loadable articles from said automatically loadable articles lift to said first ledge.

13. The system according to claim 10, wherein said automatically loadable articles transport means comprises at least one of a series of paddles and a series of fingers arranged to grip and transport said automatically loadable articles.

14. The system according to claim 11, wherein said automatically loadable articles transport means comprises at least one of a series of paddles and a series of fingers arranged to grip and transport said automatically loadable articles.

15. The system according to claim 12, wherein said automatically loadable articles transport means comprises at least one of a series of paddles and a series of fingers arranged to grip and transport said automatically loadable articles.

16. The system according to claim 1, wherein said articles comprise at least one of mail, books, magazines, and compact disks and wherein said first ledge abuts said second ledge.

17. A method for merging a plurality of articles lines to an article feeder, comprising the steps of:
automatically feeding a first line to said feeder, said first line moving over a first ledge,
automatically transporting a second line over or under said first ledge to a second ledge,
semi-automatically manoeuvring said second line onto a second ledge; and
substituting said second ledge for said first ledge.

18. The method according to claim 17, further comprising the step of substituting said first ledge for said second ledge after articles present on said second ledge have been feed to said article feeder.

19. The method according to claim 17, wherein said step of automatically feeding a first line further comprises the steps of automatically conveying said first line from a first line transport system to said feeder ledge.

20. The method according to claim 19, wherein said first line comprises a plurality of article logs in containers and said step of automatically conveying further comprises the steps of:
retrieving said article logs from a container with an article log lift; and
gripping said article logs and transporting said article logs from said containers over a first ledge to said feeder ledge.

21. The method according to claim 20, wherein said article log is about one meter long.

22. The method according to claim 17, wherein said second line comprises a plurality of articles in tubs and said step of automatically transporting further comprises the steps of:
retrieving article occupied tubs from a tub conveyor;
relocating said occupied tubs over or under said first ledge; and
returning empty tubs to said tub conveyor.

23. The method according to claim 22, wherein said step of semi-automatically manoeuvring further comprises the steps of:
manually griping a top of said articles accommodated in said occupied tub; and
turning said tub over such that said manual gripping now grips article bottoms.

24. The method according to claim 17, further comprising the steps of:
receiving articles positioned on a tray cart, and
manually relocating said articles from said tray cart to said feeder ledge.

25. The method according to claim 17, wherein said articles comprise at least one of mail, books, magazines, and compact disks.
